(19) United States
(12) Patent Application Publication
(10) Pub. No.: US 2011/0134795 A1
(43) Pub. Date: Jun. 9, 2011

(54) UNIFIED NETWORK PLANNING AND PROVISIONING

(75) Inventors: Terri L. Sutterfield, Farmersville, TX (US); Guillermo A. Arispe, Plano, TX (US); Sandy Vines, Wylie, TX (US); Gary Jones, Princeton, TX (US); Jeff Zhang, Plano, TX (US); Daniel Johnson, Plano, TX (US); Ilya Rapoport, Plano, TX (US); Enoch Tang, Allen, TX (US)

(73) Assignee: Verizon Patent and Licensing Inc., Basking Ridge, NJ (US)

(21) Appl. No.: 12/634,316

(22) Filed: Dec. 9, 2009

(51) Int. Cl. H04L 12/28

(52) U.S. Cl. 370/254

(57) ABSTRACT

An exemplary system includes a network systems database storing order information and diversity information and a link utilization database storing link utilization information. A data manager is configured to validate diversity and link utilization of the order information using the link utilization information and the diversity information. An exemplary method includes storing order information and diversity information in the network systems database, and storing link utilization information in the link utilization database. The method further includes accessing the order information, the diversity information, and the link utilization information with the data manager, and validating diversity and link utilization of the order information with the data manager using the link utilization information and the diversity information.

### BACKGROUND

Network provisioning involves a service provider preparing and equipping a network to provide network services to customers. Provisioners may be individuals who monitor network resources and provision the network accordingly. For example, a provisioner may determine whether more network resources are required to service a specific geographic area based on information available to the provisioner. Historically, it has been difficult for the provisioner to access the necessary information to properly provision the network. For example, it has been difficult for provisioners to gain access to diversity information and link utilization information. Accordingly, a system is needed that provides the provisioner with the information necessary to properly provision the network.

### BRIEF DESCRIPTION OF THE DRAWINGS

FIG. 1A illustrates an exemplary system for validating diversity and link utilization of order information;

FIG. 1B illustrates an exemplary link utilization database storing link utilization information;

FIG. 1C illustrates an exemplary network systems database storing order information and diversity information;

FIG. 1D illustrates an exemplary system having a link utilization monitor and alarm system;

FIG. 2 illustrates an exemplary method performed by the system of FIGS. 1A-D; and

FIG. 3 illustrates an exemplary method performed by a data manager to validate the order information.

### DETAILED DESCRIPTION

An exemplary system is provided that includes a network systems database storing order information and diversity information. A link utilization database stores link utilization information. The exemplary system may further include a data manager configured to validate diversity and link utilization of the order information using the link utilization information and the diversity information. Thus, a provisioner may access the diversity information and the link utilization from a unified location to receive the necessary information to properly provision the network.

An exemplary method may include storing order information and diversity information in the network systems database, storing link utilization information in the link utilization database, accessing the order information, the diversity information, and the link utilization information with the data manager, and validating diversity and link utilization of the order information with the data manager using the link utilization information and the diversity information.

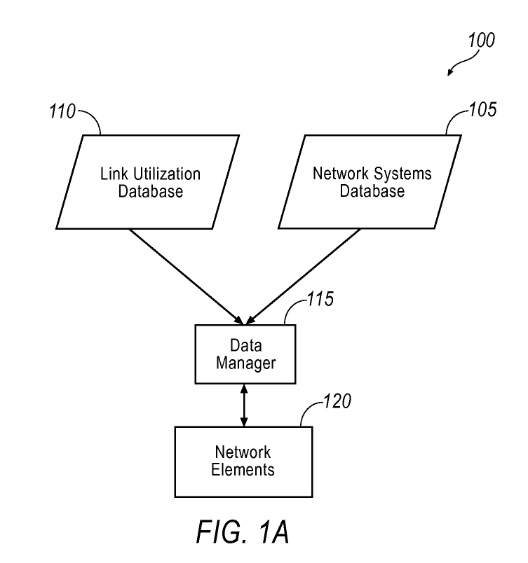

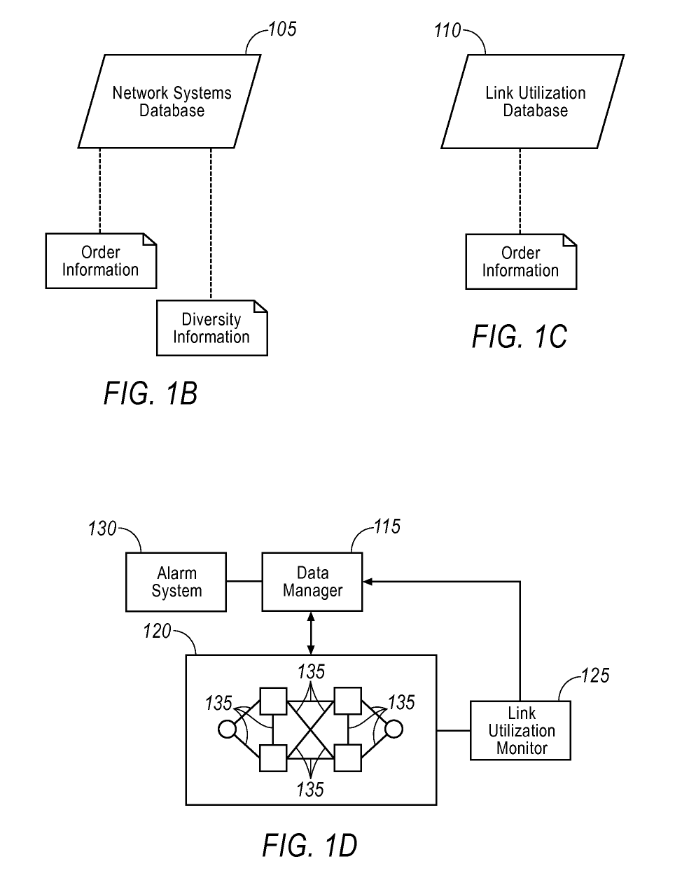

As illustrated in FIG. 1A, system 100 includes a network systems database 105, a link utilization database 110, and a data manager 115. The system 100 may further include one or more network elements 120 in communication with the data manager 115. A link utilization monitor 125 may be in communication with one or more of the network elements 120. The network systems database 105, the link utilization database 110, the data manager 115, and the network elements 120 may communicate with one another over one or more communication networks implementing one or more network communication protocols. For example, the communication network may implement a signaling system 7 (SS7) network protocol. The system 100 may take many different forms and include multiple and/or alternate components and facilities. While an exemplary system 100 is shown in FIG. 1A, the exemplary components illustrated in the figure are not intended to be limiting. Indeed, additional or alternative components and/or implementations may be used.

Referring to FIGS. 1A and 1B, the network systems database 105 may be stored on one or more servers and include various types of information, including order information and diversity information. Order information may include any data regarding requested changes in the network provisioning. For example, the order information may include orders indicating that additional network resources are recommended or needed to maintain a minimum quality of service requirement for communications between one or more of the network elements 120. Diversity information may include any data regarding the diversity requirements of the network resources. For example, the diversity requirements may specify that a predetermined number of alternate paths are required for each link between network elements 120.

Referring to FIGS. 1A and 1C, the link utilization database 110 may be stored on one or more servers and configured to store link utilization information for one or more of the links connecting various network elements 120. For example, one or more link utilization monitors 125 (see FIG. 1D) may be used to monitor the link utilization of one or more of the network elements 120. The link utilization monitor 125 may quantify the amount of link utilization as link utilization information and store the link utilization information in the link utilization database 110. The link utilization information may be used to determine whether the quality of service requirements, diversity requirements, or both, for one or more network elements 120 is violated.

Referring again to FIG. 1A, the data manager 115 may be configured to access the network systems database 105 and the link utilization database 110 to, for example, validate diversity and link utilization of the order information and provide a provisioner with a unified location to access orders, link utilization information, and diversity information. For example, the data manager 115 may be configured to query the network systems database 105 for the order information and the diversity information and query the link utilization database 110 for the link utilization information. Alternatively, one or both of the network systems database 105 and the link utilization database 110 may push the order information, the diversity information, and the link utilization information to the data manager 115 upon request from a provisioner, at predetermined times, or in response to one or more predetermined events (e.g., when link utilization exceeds a predetermined level).

The data manager 115 may allow a provisioner to assign and pre-reserve links for projects and orders, as well as allow the provisioner to access various types of information (e.g., diversity and order information) from the network systems database 105. In one exemplary approach, the data manager 115 may be configured to automatically populate orders stored on the network systems database 105 for the provisioner based on what the provisioner reserved or assigned. The data manager 115 may further be configured to track modifications to orders (e.g., changes, additions, deletions, etc.) as well as user activities on the network systems database 105. Using the data manager 115, the provisioner may also view link utilization information stored in the link utilization database 110.

The data manager 115 may be further configured to compare the order information to the link utilization information and the diversity information. As previously discussed, the link utilization information quantifies the amount of link utilization while the diversity information sets forth the diversity requirements. The data manager 115 may analyze the order information, the link utilization information, and the diversity information to determine whether the order, once provisioned, will satisfy the diversity requirements in light of the link utilization information.

In one exemplary approach, the diversity information may call for a predetermined diversity requirement of, e.g., at least two links to connect two different network elements 120. Furthermore, the diversity information may define that the link utilization of each node should not exceed a predetermined link utilization of, for example, forty percent (40%). Therefore, the data manager 115 may analyze the order information to determine whether the order establishes at least two links between each network element and that the number of links will be sufficient, e.g., the utilization of each link will not exceed forty percent (40%). Alternatively, if the link utilization information indicates that each link has, for example, forty-two percent (42%) utilization over an extended period of time, the data manager 115 may generate an order indicating that another link is required to satisfy the minimum diversity requirements.

If the data manager 115 determines that the order information satisfies the link utilization requirements and the diversity requirements, then the data manager 115 may authorize the order for processing. If not, the data manager 115 may automatically generate a new order or recommend changes to the order that would satisfy the link utilization and diversity requirements. The data manager 115 may be configured to notify the provisioner that a new order has been created or that the existing order does not satisfy the link utilization and diversity requirements.

The provisioner may access the data manager 115 with a computer. In one exemplary approach, the data manager 115 may be an application on a local computer or accessible using a remote computer via a network. To gain access to the data manager 115, the provisioner may be required to input credentials, such as a user name and password. The data manager 115 may authenticate the provisioner's credentials and grant the provisioner access if authenticated. Once granted access, the provisioner may use the data manager 115 to, for example, view the order information, diversity information, link utilization information, and generate new orders. The data manager 115 may be further configured to receive search criteria from the provisioner and query the network systems database 105 and the link utilization database 110 with the search criteria.

In one exemplary illustration, the provisioner may use the data manager 115 to reserve new links when new links are to be provisioned. Therefore, the data manager 115 may prevent other provisioners from provisioning the reserved links before the order is processed. For example, when a new link is reserved, the data manager 115 may query the order information to determine whether any unprocessed orders exist that use the new links. If the new link has already been provisioned, the data manager 115 may notify the provisioner that the new link is unavailable. If the new link is available for provisioning, the data manager 115 may communicate that the new link is available to the provisioner.

The network elements 120 may include any number of hardware or software devices used to implement a communication network. For example, the network elements 120 may include any number of switches, routers, hubs, links, etc. The network elements 120 may be used to implement various communication protocols, such as a signaling system 7 (SS7) network protocol. In the SS7 network protocol, the network elements 120 may include service switching points, signal transfer points, and service control points. Each of the network elements 120 may be connected via one or more links 135. Each link 135 may allow data to travel between network elements 120. The links 135 may be arranged to provide diversity. For example, there may be at least two links 135 connecting each network element 120. That way, if one link 135 fails, communication between network elements 120 remains possible.

Referring now to FIG. 1D, the system 100 may include an alarm system 130 and a link utilization monitor 125 in communication with the data manager 115. The link utilization monitor 125 may further be in communication with one or more of the network elements 120.

The link utilization monitor 125 may be configured to monitor the network traffic across one or more of the links 135. The link utilization monitor 125 may be further configured to quantify the amount of traffic as link utilization information, for example, and store the link utilization information in the link utilization database 110. The system 100 may include any number of link utilization monitors 125. For example, the link utilization monitor 125 may be configured to gather network information, including the link utilization information, from the network elements 120, and allow a user to configure the network. The link utilization monitor 125 may include one or more monitoring platforms configured to collect data from various network elements 120, including nodes and linksets 135, and transmit the information collected to the data manager 115. Moreover, the link utilization monitor 125 may be configured to transmit graphical information to the data manager 115 so that a user may view graphical maps of the network elements 120.

The alarm system 130 may be in communication with the data manager 115 and one or more network elements 120. The alarm system 130 may be configured to generate an alarm or notification when an existing link 135 fails to satisfy the link utilization or diversity requirements. In one exemplary approach, the data manager 115 may be configured to transmit the diversity information and the link utilization information to the alarm system 130. If an existing link 135 fails to meet the predetermined diversity requirements or the predetermined link utilization, the alarm system 130 may generate a notification to the provisioner of the failed requirement. Moreover, if an order exists to establish a new link that does not satisfy the predetermined diversity and link utilization requirements, the alarm system 130 may generate a notification to the provisioner. However, with the diversity information and the link utilization information, the alarm system 130 can determine whether the links were properly provisioned (e.g., to satisfy the diversity and link utilization requirements) before generating the notification. If a link 135 were properly provisioned, the notification from the alarm system 130 may indicate that a repair crew should or has been sent to repair the malfunctioning link 135. However, if the link 135 was not provisioned properly, the alarm system 130 may automatically generate an order to remedy the improper provisioning. Alternatively, the alarm system 130 may communicate the improper provisioning to the data manager 115, and the data manager 115 may automatically generate the new order that properly provisions the link 135.

In general, computing systems and/or devices, such as the data manager 115, the link utilization monitor 125, the alarm system 130, and one or more of the network elements 120, may employ any of a number of well known computer operating systems, including, but by no means limited to, known versions and/or varieties of the Microsoft Windows® operating system, the Unix operating system (e.g., the Solaris® operating system distributed by Sun Microsystems of Menlo Park, Calif.), the AIX UNIX operating system distributed by International Business Machines of Armonk, N.Y., and the Linux operating system. Examples of computing devices include, without limitation, a computer workstation, a server, a desktop, notebook, laptop, or handheld computer, or some other known computing system and/or device.

Computing devices generally include computer-executable instructions, where the instructions may be executable by one or more computing devices such as those listed above. Computer-executable instructions may be compiled or interpreted from computer programs created using a variety of well known programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of known computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein, such as the network systems database 105 and the link utilization database 110, may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners, as is known. A file system may be accessible from a computer operating system, and may include files stored in various formats. An RDBMS generally employs the known Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

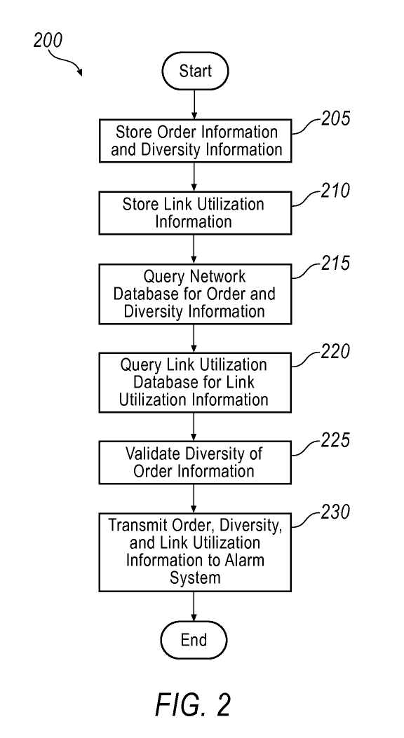

FIG. 2 illustrates an exemplary process 200 employed by the system 100.

Block 205 may include storing order information and diversity information in the network systems database 105. For example, the order information may be automatically generated by the data manager 115 or manually entered by the provisioner. The diversity information may include the predetermined diversity requirements for links 135 between one or more of the network elements 120.

Block 210 may include storing link utilization information in the link utilization database 110. For example, the link utilization monitor 125 may track the link utilization of one or more network elements 120. The link utilization monitor 125 may further store the link utilization information in the link utilization database 110 so that the link utilization information may be viewed by the provisioner or accessed by the data manager 115.

Block 215 may include querying the network systems database 105 to access the order information and the diversity information. For example, the provisioner may input search criteria into the data manager 115, and the data manager 115 may run the search on the network systems database 105. Further, the data manager 115 may present the search results to the provisioner.

Block 220 may include querying the link utilization database 110 to access the link utilization information. For example, the provisioner may input search criteria into the data manager 115, and the data manager 115 may run the search on the link utilization database 110. As with the order information and diversity information, the data manager 115 may present the search results to the provisioner.

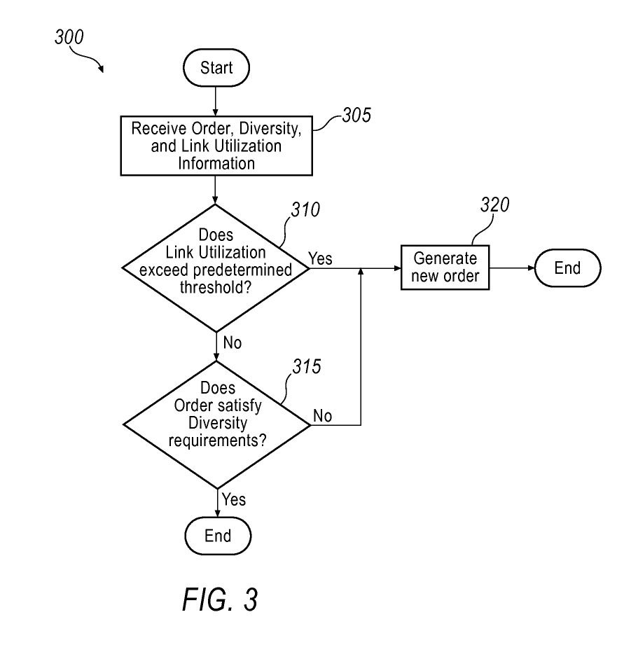

Block 225 may include validating diversity and link utilization of the order information with the data manager 115 using the link utilization information and the diversity information, which is described in greater detail below with respect to FIG. 3. By validating the diversity and link utilization of the order, the provisioner can verify that the order meets the predetermined diversity requirements and predetermined link utilization requirements.

Block 230 may include transmitting the order information, the diversity information, and the link utilization information to the alarm system 130. Therefore, if the alarm system 130 detects situations that trigger an alarm (e.g., diversity requirements or link utilization requirements are being violated), the alarm system 130 can automatically determine whether the links were provisioned properly (i.e., to meet the diversity and link utilization requirements) and notify the provisioner or automatically generate a new order to properly provision the network.

The process 200 may end after block 230.

FIG. 3 includes an exemplary process 300 for validating the diversity and link utilization of the order information.

Block 305 may include receiving the order information, the diversity information, and the link utilization at, for example, the data manager 115. As previously discussed, the data manager 115 may receive the order information and diversity information from the network systems database 105, and the link utilization information from the link utilization database 110. Moreover, the data manager 115 may query the network systems database 105 for the order information and diversity information, and the data manager 115 may query the link utilization database 110 for the link utilization information.

Decision point 310 may include determining whether the link utilization exceeds a predetermined link utilization threshold. For example, the predetermined link utilization requirements may designate a link utilization threshold (e.g., the maximum allowable link utilization). The data manager 115 may analyze the order information in light of the link utilization information and determine whether additional orders are needed. In one exemplary approach, the link utilization requirements may designate that a single link 135 should have no more than 40% link utilization over a given period of time. If one or more of the links 135 defined by the order exceed the link utilization requirements, the process 300 moves to block 320, described in further detail below. However, if none of the links 135 exceed the link utilization requirement, the process 300 moves to block 315.

Decision point 315 may include determining whether the order satisfies the diversity requirements. For example, if the diversity requirements specify at least two links 135 between network elements 120, the data manager 115 may analyze the order information to determine whether the order includes at least two links 135 between each network element. If the order satisfies the diversity requirements, the process 300 ends. If the order does not satisfy the diversity requirements (e.g., there is only one link 135 between network elements 120), the process 300 continues with block 320.

Block 320 includes generating a new order. In one exemplary approach, the data manager 115 may generate the new order to establish one or more additional links 135 between network elements 120 to satisfy the link utilization requirements. Furthermore, the data manager 115 may generate the new order to establish one or more additional links between network elements 120 to satisfy the diversity requirements.

The process 300 may end after the new order is generated.

### CONCLUSION

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent upon reading the above description. The scope of the invention should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the invention is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A system, comprising:
a network systems database storing order information and diversity information;
a link utilization database storing link utilization information;
a data manager configured to validate diversity and link utilization of said order information using said link utilization information and said diversity information.

2. A system as set forth in claim 1, wherein said data manager is configured to access said order information, said diversity information, and said link utilization information.

3. A system as set forth in claim 1, wherein said data manager is configured to query said network systems database for at least one of said order information and said diversity information.

4. A system as set forth in claim 1, wherein said data manager is configured to query said link utilization database for said link utilization information.

5. A system as set forth in claim 1, wherein said data manager is configured to generate a new order based on said link utilization information.

6. A system as set forth in claim 5, wherein said data manager is configured to generate the new order when link utilization exceeds a predetermined threshold.

7. A system as set forth in claim 1, wherein said data manager is configured to generate a new order based on said diversity information.

8. A system as set forth in claim 7, wherein said data manager is configured to generate the new order when an existing order fails to satisfy a predetermined diversity requirement.

9. A system as set forth in claim 1, further comprising an alarm system in communication with said data manager, wherein said data manager is configured to transmit said diversity information and said link utilization information to said alarm system.

10. A method comprising:
storing order information and diversity information in a network systems database;
storing link utilization information in a link utilization database;
accessing the order information, the diversity information, and the link utilization information with a data manager; and
validating diversity and link utilization of the order information with the data manager using the link utilization information and the diversity information.

11. A method as set forth in claim 10, further comprising querying the network systems database for at least one of the order information and the diversity information.

12. A method as set forth in claim 10, further comprising querying the link utilization database for the link utilization information.

13. A method as set forth in claim 10, further comprising generating a new order based on the link utilization information.

14. A method as set forth in claim 13, wherein generating the new order includes generating the new order when link utilization exceeds a predetermined threshold.

15. A method as set forth in claim 10, further comprising generating a new order based on the diversity information.

16. A method as set forth in claim 15, wherein generating the new order based on the diversity information includes generating the new order when an existing order fails to satisfy a predetermined diversity requirement.

17. A method as set forth in claim 10, further comprising transmitting the diversity information and the link utilization information to an alarm system.

18. A computer-readable medium tangibly embodying computer-executable instructions comprising:
accessing order information, diversity information, and link utilization information; and
validating diversity and link utilization of the order information using the link utilization information and the diversity information.

19. A computer-readable medium as set forth in claim 18, further comprising querying the network systems database for at least one of the order information and the diversity information.

20. A computer-readable medium as set forth in claim 18, further comprising querying a link utilization database for the link utilization information.

21. A computer-readable medium as set forth in claim 18, further comprising generating a new order based on the link utilization information.

22. A computer-readable medium as set forth in claim 21, wherein generating the new order includes generating the new order when link utilization exceeds a predetermined threshold.

23. A computer-readable medium as set forth in claim 18, further comprising generating a new order based on the diversity information.

24. A computer-readable medium as set forth in claim 23, wherein generating the new order based on the diversity information includes generating the new order when an existing order fails to satisfy a predetermined diversity requirement.

25. A computer-readable medium as set forth in claim 18, further comprising transmitting the diversity information and the link utilization information to an alarm system.
